(19) United States
(12) Patent Application Publication
(10) Pub. No.: US 2016/0169114 A1
(43) Pub. Date: Jun. 16, 2016

(54) SHIELD ASSEMBLY FOR SHIELDING A HOUSING OF AN ELECTRO-MECHANICAL DEVICE FROM A HOT BODY

(71) Applicant: Solar Turbines Incorporated, San Diego, CA (US)

(72) Inventors: Cody Charles Howarth, La Mesa, CA (US); Gregory Palczewski, San Diego, CA (US); Nicholas Owen Saintarbor, San Diego, CA (US)

(73) Assignee: Solar Turbines Incorporated, San Diego, CA (US)

(21) Appl. No.: 14/571,829

(22) Filed: Dec. 16, 2014

(51) Int. Cl. F02C 7/24; F01D 25/24; F02C 9/18

(52) U.S. Cl. CPC F02C 7/24; F02C 9/18; F01D 25/24; F05D 2260/231; F05D 2220/32

(57) ABSTRACT

A shield assembly for shielding a housing of an electro-mechanical device from a hot body includes a first sidewall and a second sidewall disposed in a spaced apart relation from each other. A third sidewall extends between the first sidewall and the second sidewall to define a space therebetween. The first, second, and third sidewalls are configured to receive the housing of the electro-mechanical device in the space defined therebetween. The shield assembly further includes a backing plate extending laterally from a bottom end of at least one of the first, second, and third sidewalls. The backing plate is releasably fastened with a bottom end of the housing. The shield assembly further includes a tab member extending away from a top end of at least one of the first, second, and third sidewalls. The tab member is releasably fastened with a bracket associated with the housing of the electro-mechanical device.

### TECHNICAL FIELD

The present disclosure relates to a shield assembly. More particularly, the present disclosure relates to a shield assembly for shielding a housing of an electro-mechanical device from a hot body such as, for e.g., a combustor system of a gas turbine engine.

### BACKGROUND

Typically, machines such as, but not limited to, engines, gas turbine engines, and the like radiate heat during operation. In some cases, these machines may be connected or affixed on their exterior with components that are sensitive to heat. With exposure to heat radiated from the machine, a service life of the components may reduce and the components may cease to perform the intended functions. Moreover, in some cases, upon prolonged exposure to heat or with exposure to extreme heat conditions, the components may altogether fail thus negatively impacting the working of the machine itself.

Hence, there is a need for a system that can shield the heat sensitive components from the heat radiated from a machine.

### SUMMARY OF THE DISCLOSURE

In one aspect of the present disclosure, a shield assembly for shielding a housing of an electro-mechanical device from a hot body includes a first sidewall and a second sidewall disposed in a spaced apart relation from each other. The shield assembly further includes a third sidewall extending between opposing ends of the first sidewall and the second sidewall to define a space therebetween. The first, second, and third sidewalls are configured to receive the housing of the electro-mechanical device in the space defined therebetween.

The shield assembly further includes a backing plate extending laterally from a bottom end of at least one of the first, second, and third sidewalls. The backing plate is configured to be releasably fastened with a bottom end of the housing. The shield assembly further includes a tab member extending away from a top end of at least one of the first, second, and third sidewalls. The tab member is configured to be releasably fastened with a bracket associated with the housing of the electro-mechanical device.

In another aspect of the present disclosure, a method of shielding a housing of an electro-mechanical device from a hot body includes providing a first sidewall and a second sidewall in a spaced apart relation from each other. The method further includes providing a third sidewall extending between opposing ends of the first sidewall and the second sidewall such that the first, second, and third sidewalls define a space therebetween. The first, second, and third sidewalls are configured to receive the housing of the electro-mechanical device in the space defined therebetween.

The method further includes providing a backing plate extending laterally from a bottom end of at least one of the first, second, and third sidewalls such that the backing plate is configured to be releasably fastened with a bottom end of the housing. The method further includes providing a tab member extending away from a top end of at least one of the first, second, and third sidewalls such that the tab member is configured to be releasably fastened with a bracket associated with the housing of the electro-mechanical device.

Other features and aspects of this disclosure will be apparent from the following description and the accompanying drawings.

### BRIEF DESCRIPTION OF THE DRAWINGS

FIG. 1 is a side perspective view of an exemplary machine employing a shield assembly, in accordance with an embodiment of the present disclosure;

FIG. 2 is a side perspective view of the exemplary machine from FIG. 1, the exemplary machine being rendered with a zoomed-in aspect to show a bleed valve therein;

FIG. 3 is a bottom view of the exemplary machine and the shield assembly, in accordance with an embodiment of the present disclosure;

FIG. 4 is a bottom perspective view of the shield assembly releasably mounted to a housing of a bleed valve actuator, in accordance with an embodiment of the present disclosure;

FIG. 5 is a bottom perspective view of the shield assembly without the housing of the bleed valve actuator; and

FIG. 6 is a method flowchart showing steps for shielding the housing of the bleed valve actuator from heat radiated by the machine, in accordance with an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

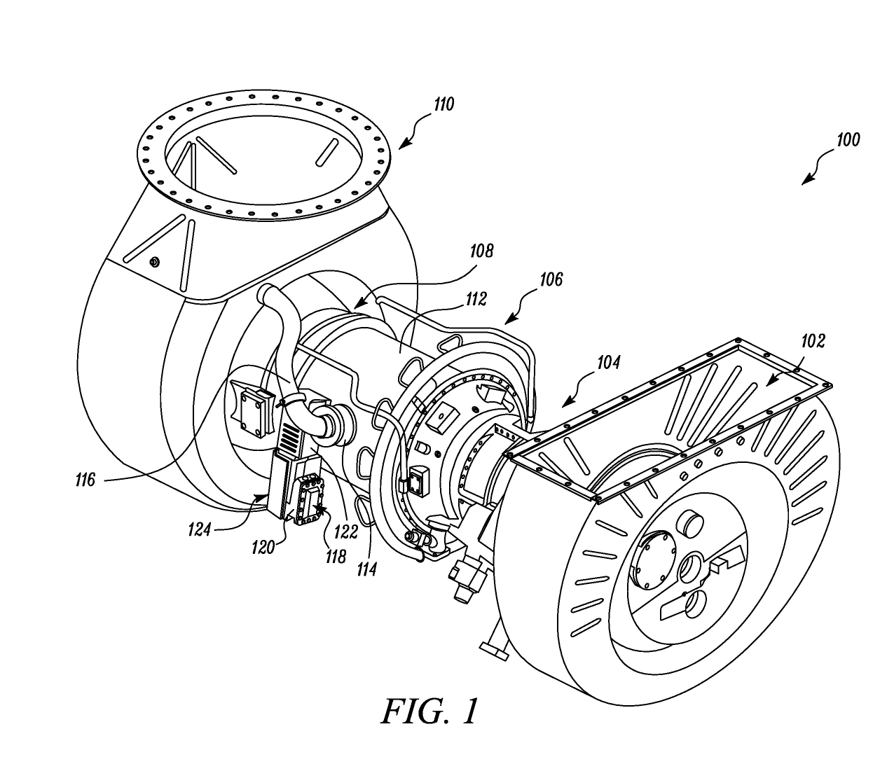

FIG. 1 shows a side perspective view of an exemplary machine 100, in accordance with an embodiment of the present disclosure. In the illustrated embodiment of FIG. 1, the machine 100 is embodied in the form of a gas turbine engine. The gas turbine engine may be of any type. In one embodiment, the gas turbine engine 100 may be used to drive a generator for power generation, or other mechanical assemblies such as a compressor. In other embodiments, the machine 100 may be any other type of engine, or device such as motors, furnaces, boilers and the like.

For the sake of convenience and simplicity, ‘the machine’ will hereinafter be referred to as ‘the gas turbine engine’ and designated with the same reference numeral ‘100’. Although the gas turbine engine 100 has been disclosed herein, it may be noted that the present disclosure is not limited to a gas turbine engine. Rather, one of skill in the art will appreciate that the present disclosure may be similarly applied to other types of machines that have a ‘hot body’ radiating heat therefrom. As disclosed earlier herein, other types of machines that may radiate heat may include engines, electric motors, furnaces, boilers, but are not limited thereto.

Referring to FIG. 1, the gas turbine engine 100 includes an inlet system 102, a compressor system 104, a combustor system 106, a turbine system 108, and an exhaust system 110. The inlet system 102 is configured to draw and supply air from the atmosphere to the compressor system 104. The compressor system 104 may compress the supplied air and operatively provide the compressed air to various components of the combustor system 106 and the turbine system 108, the compressed air also serving purposes in the gas turbine engine 100 such as, but not limited to, venting, and escaping through the exhaust system 110.

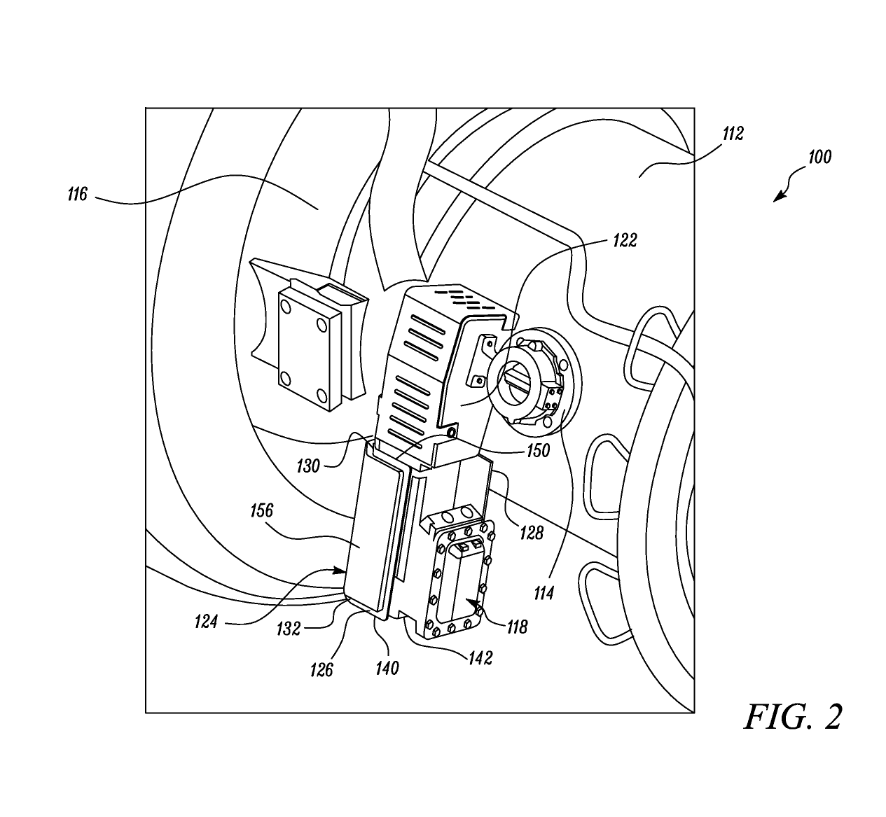

In the illustrated embodiment of FIG. 1, the combustor system 106 may be regarded as a ‘hot body’ for the purposes of the present disclosure as the combustor system 106 may radiate heat into the surroundings during operation of the gas turbine engine 100. Further, referring to FIG. 2, the combustor system 106 has a shroud 112 that is provided with a bleed valve 114 disposed thereon. The bleed valve 114 is in fluid communication with the exhaust system 110 via a bleed hose 116. The bleed valve 114 is coupled with a bleed valve actuator 118 (hereinafter referred to as ‘actuator’ and designated with the same reference numeral ‘118’) to selectively bleed off any excess air via the bleed hose 116 to the exhaust system 110.

As shown in FIG. 2, the actuator 118 includes a housing 120 that is configured to enclose components and/or circuitry (not shown) associated with the actuator 118. The components and/or circuitry disclosed herein may be configured to execute functions required by the actuator 118 i.e., selectively opening and closing of the bleed valve 114. Moreover, a bracket 122 may be associated with the actuator 118. More specifically, as shown in FIG. 2, the bracket 122 is disposed above the actuator 118 and is sized and configured to enclose linkages (not shown) associated with the actuator 118. These linkages are configured to execute pre-determined motions in order to accomplish the opening and the closing of the bleed valve 114.

The present disclosure relates to a shield assembly 124 for shielding the housing 120 of the actuator 118 from the heat radiated by the combustor system 106. Although, the shield assembly 124 disclosed herein is explained in conjunction with the bleed valve actuator 118, it will be appreciated that the shield assembly 124 of the present disclosure may be optionally implemented with various other types of electro-mechanical devices or heat sensitive components that are typically known to one skilled in the art.

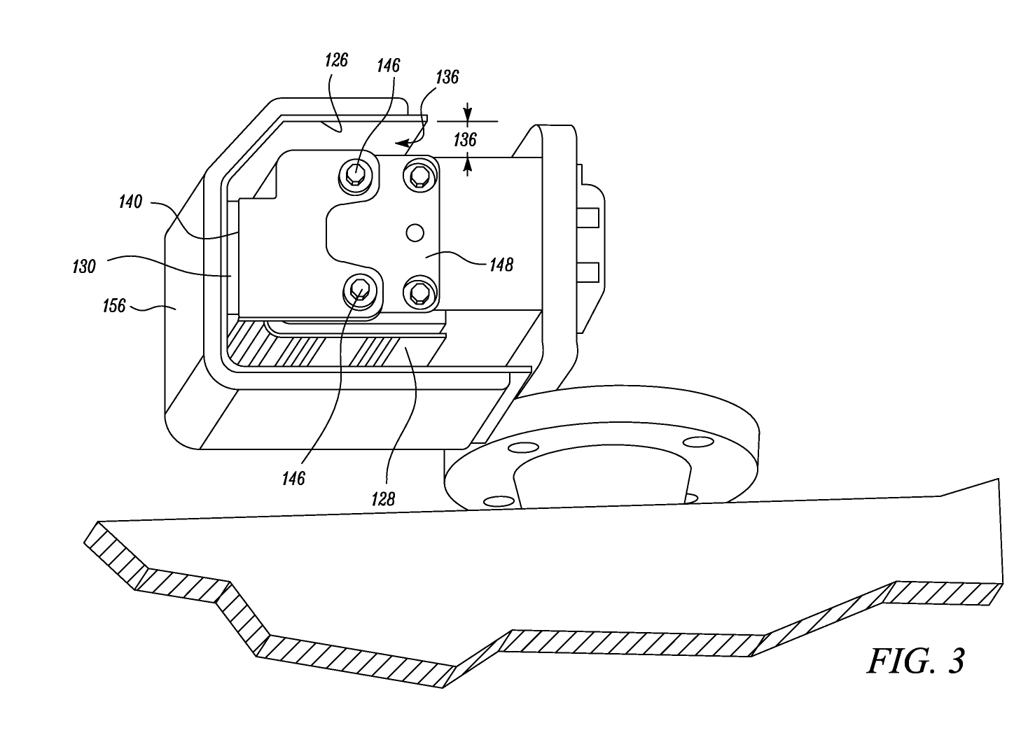

With continued reference to FIG. 2, the shield assembly 124 includes a first sidewall 126 and a second sidewall 128 disposed in a spaced apart relation from each other. Further, referring to FIGS. 2 and 3, the shield assembly 124 further includes a third sidewall 130 extending between opposing ends 132 of the first sidewall 126 and the second sidewall 128 to define a space 134 therebetween. The first, second, and third sidewalls 126, 128, and 130 are configured to receive the housing 120 of the electro-mechanical device i.e., the actuator 118 in the space 134 defined therebetween.

In an embodiment as shown in FIG. 3, the space 134 defined between the first, second, and third sidewall 126, 128, and 130 is substantially greater than a size of the housing 120 received therein. The shield assembly 124 is further configured to define an air gap 136 between the housing 120 of the actuator 118 and each of the first sidewall 126, the second sidewall 128, and the third sidewall 130.

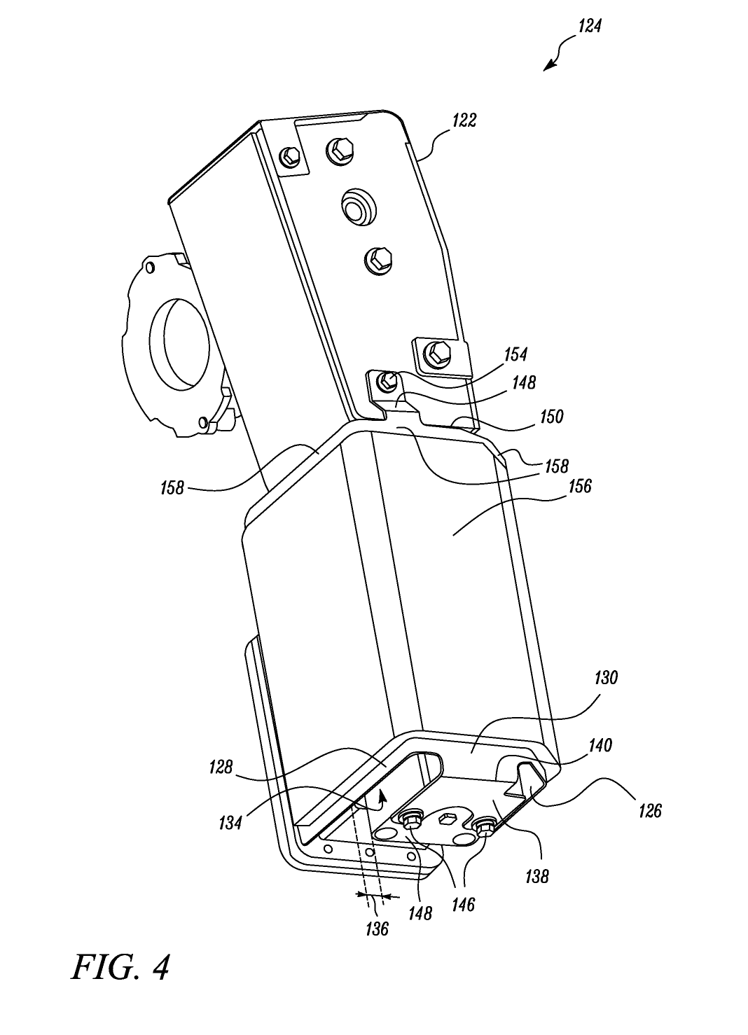

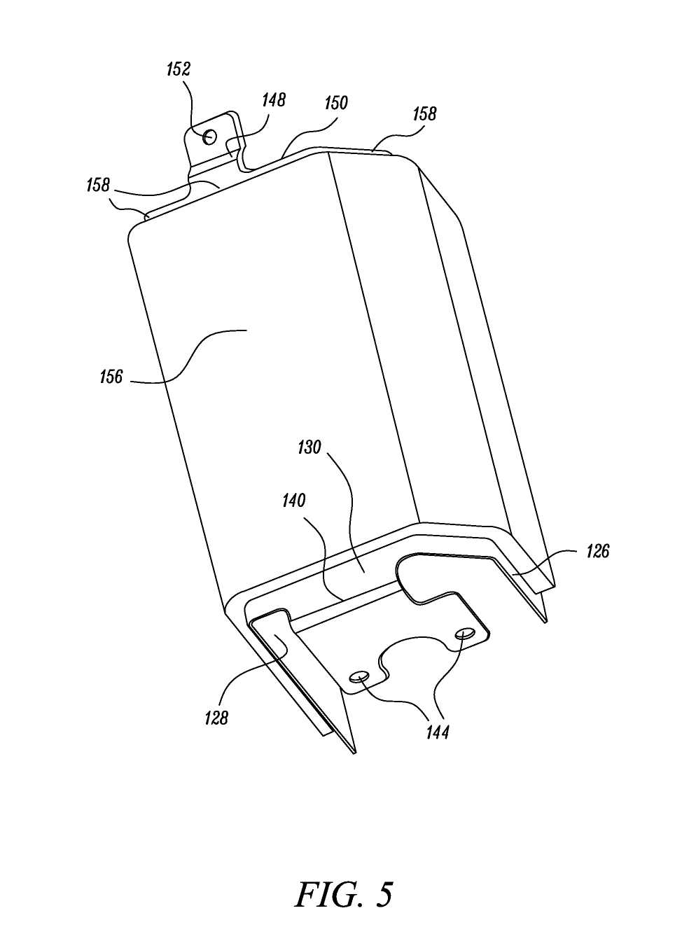

The shield assembly 124 further includes a backing plate 138 extending laterally from a bottom end 140 of at least one of the first, second, and third sidewalls 126, 128, and 130. In the illustrated embodiment of FIGS. 4 and 5, the backing plate 138 is shown to extend laterally from the third sidewall 130 of the shield assembly 124. However, in alternative embodiments, the backing plate 138 may optionally be configured to extend laterally from the first sidewall 126 or the second sidewall 128 in lieu of the third sidewall 130 disclosed herein.

The backing plate 138 is configured to be releasably fastened with a bottom end 142 of the housing 120. As shown in FIGS. 4 and 5, the backing plate 138 is defined with at least one aperture 144 so as to receive a fastener 146 therein (two apertures 144 and fasteners 146 shown in the illustrated embodiment of FIGS. 4-5). The apertures 144 and fasteners 146 help to releasably fasten the shield assembly 124 with the bottom end 142 of the housing 120. The bottom end 142 of the housing 120 may be correspondingly defined with suitable threaded receptacles (not shown) to engage with the fasteners 146. The fasteners 146 may include hex bolts, Allen screws, grub screws, or any other type of fastener commonly known to one skilled in the art.

With continued reference to FIGS. 4 and 5, the shield assembly 124 further includes a tab member 148 extending away from a top end 150 of at least one of the first, second, and third sidewalls 126, 128, and 130. In the illustrated embodiment of FIGS. 4 and 5, the tab member 148 is shown to extend away from the third sidewall 130 of the shield assembly 124. However, in alternative embodiments, the tab member 148 may optionally be configured to extend away from the first sidewall 126 or the second sidewall 128 in lieu of the third sidewall 130 disclosed herein.

The tab member 148 is configured to be releasably fastened with the bracket 122 that is associated with the housing 120 of the actuator 118. As shown in FIGS. 4 and 5, the tab member 148 is defined with at least one aperture 152 so as to receive a fastener 154 therein. Although one aperture 154 is defined on the tab member 148 in the illustrated embodiment of FIGS. 4-5, two or more apertures may optionally be defined on the tab member 148 depending on specific requirements of an application. The aperture 152 and the fastener 154 help to releasably fasten the shield assembly 124 with the bracket 122 associated with the housing 120. The fastener 154 may include a hex bolt, an Allen screw, a grub screw, or any other type of fastener commonly known to one skilled in the art. The bracket 122 may be correspondingly defined with a suitable threaded receptacle (not shown) to engage with the fastener 154.

In an embodiment as shown in FIGS. 2-5, the shield assembly 124 further includes an insulating jacket 156. The insulating jacket 156 is disposed on an outer surface 158 (best seen in FIGS. 3-4) of the first, second, and third sidewalls 126, 128, and 130. The insulating jacket 156 is configured to reduce heat transfer from the combustor system 106 to the housing 120 of the actuator 118. The insulating jacket 156 may be made up of a fiberglass material that is wrapped around with the help of a thin sheet metal foil (not shown). Optionally, the insulating jacket 156 may be made up of an asbestos material. However, it may be noted that one of ordinary skill can beneficially contemplate using other materials in lieu of the fiberglass or the asbestos materials disclosed herein. Moreover, a type or nature of material used for the insulating jacket 156 may be selected depending on specific requirements of an application.

Various embodiments disclosed herein are to be taken in the illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

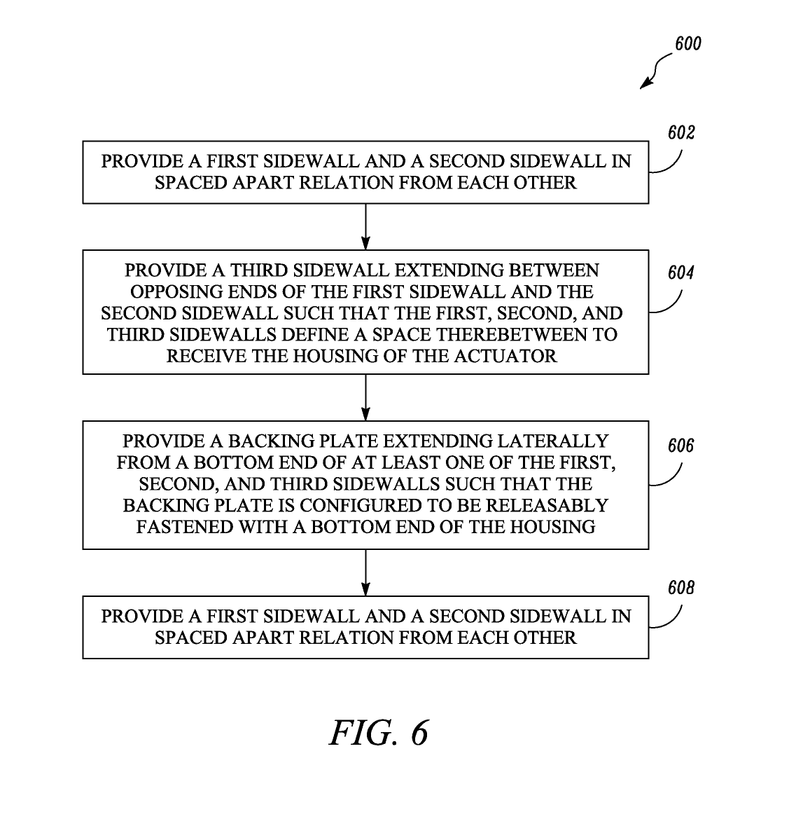

FIG. 6 illustrates a method 600 of shielding the housing 120 of the actuator 118 from the combustor system 106. At step 602, the method 600 includes providing the first sidewall 126 and the second sidewall 128 in a spaced apart relation from each other. At step 604, the method 600 further includes providing the third sidewall 130 extending between opposing ends 132 of the first sidewall 126 and the second sidewall 128 such that the first, second, and third sidewalls 126, 128, and 130 define the space 134 therebetween. As disclosed earlier herein, the first, second, and third sidewalls 126, 128, and 130 are configured to receive the housing 120 of the actuator 118 in the space 134 defined therebetween.

At step 606, the method 600 further includes providing the backing plate 138 extending laterally from the bottom end 140 of at least one of the first, second, and third sidewalls 126, 128, and 130 such that the backing plate 138 is configured to be releasably fastened with the bottom end 142 of the housing 120.

At step 608, the method 600 further includes providing the tab member 148 extending away from the top end 150 of at least one of the first, second, and third sidewalls 126, 128, and 130 such that the tab member 148 is configured to be releasably fastened with the bracket 122 associated with the housing 120 of the actuator 118.

In an embodiment, the method 600 may further include providing the insulating jacket 156 on the outer surface 158 of the first, second, and third sidewalls 126, 128, and 130 such that the insulating jacket 156 is configured to reduce heat transfer from the shroud 112 of the combustor system 106 to the housing 120 of the actuator 118. As disclosed earlier herein, the insulating jacket 156 may be made up of a fiberglass material or an asbestos material, but is not limited thereto. A type and nature of material selected for the insulating jacket 156 may vary from one application to another depending on specific requirements of an application.

In methodologies directly or indirectly set forth herein, various steps and operations are described in one possible order of operation, but those skilled in the art will recognize that steps and operations may be re-arranged, replaced, or eliminated without departing from the spirit and scope of the present disclosure as set forth in the claims.

Embodiments of the present disclosure have applicability for use in preventing heat from being radiated from a ‘hot body’ into a heat sensitive component, for e.g., from the shroud 112 of the combustor system 106 into the bleed valve actuator 118. With implementation of the shield assembly 124 disclosed herein, the air gap 136 and the insulating jacket 156 together help the heat sensitive components located in the vicinity of a hot body to be maintained at a temperature significantly lower than that of the hot body. Therefore, with a cooler working environment for the heat sensitive components, a service life of the components may be prolonged. In this case, with use of the shield assembly 124 on the bleed valve actuator 118, a service life of the bleed valve actuator 118 may be prolonged as the bleed valve actuator 118 is prevented from direct exposure to heat radiated from the combustor system 106. Moreover, as the actuator 118 has been rendered less prone to failure, costs previously incurred with maintenance or repair of the actuator 118 may be offset. Furthermore, with use of the shield assembly 124 disclosed herein, an operation of the bleed valve actuator 118 may be smooth and easy.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A shield assembly for shielding a housing of an electro-mechanical device from a hot body, the shield assembly comprising:
a first sidewall and a second sidewall disposed in a spaced apart relation from each other;
a third sidewall extending between opposing ends of the first sidewall and the second sidewall to define a space therebetween, wherein the first, second, and third sidewalls are configured to receive the housing of the electro-mechanical device in the space defined therebetween;
a backing plate extending laterally from a bottom end of at least one of the first, second, and third sidewalls, the backing plate configured to be releasably fastened with a bottom end of the housing; and
a tab member extending away from a top end of at least one of the first, second, and third sidewalls, the tab member configured to be releasably fastened with a bracket associated with the housing of the electro-mechanical device.

2. The shield assembly of claim 1 further comprising an insulating jacket disposed on an outer surface of the first, second, and third sidewalls, the insulating jacket configured to reduce heat transfer from the hot body to the housing of the electro-mechanical device.

3. The shield assembly of claim 2, wherein the insulating jacket is made up of a fiberglass material.

4. The shield assembly of claim 1, wherein the space defined between the first, second, and third sidewalls is substantially greater than a size of the housing received therein.

5. The shield assembly of claim 4 further configured to define an air gap between the housing of the electro-mechanical device and each of the first sidewall, the second sidewall, and the third sidewall.

6. The shield assembly of claim 1 further comprising at least one aperture defined on the backing plate, the aperture on the backing plate configured to receive a fastener therein for releasably fastening the shield assembly with the bottom end of the housing.

7. The shield assembly of claim 1 further comprising at least one aperture defined on the tab member, the aperture on the tab member configured to receive a fastener therein for releasably fastening the shield assembly with the bracket associated with the housing.

8. A machine including:
a hot body configured to radiate heat; and
employing the shield assembly of claim 1.

9. The machine of claim 8, wherein the machine is a gas turbine engine.

10. A method of shielding a housing of an electro-mechanical device from a hot body, the method comprising:
providing a first sidewall and a second sidewall in a spaced apart relation from each other;
providing a third sidewall extending between opposing ends of the first sidewall and the second sidewall such that the first, second, and third sidewalls define a space therebetween, wherein the first, second, and third sidewalls are configured to receive the housing of the electro-mechanical device in the space defined therebetween;
providing a backing plate extending laterally from a bottom end of at least one of the first, second, and third sidewalls such that the backing plate is configured to be releasably fastened with a bottom end of the housing; and
providing a tab member extending away from a top end of at least one of the first, second, and third sidewalls such that the tab member is configured to be releasably fastened with a bracket associated with the housing of the electro-mechanical device.

11. The method of claim 10 further comprising providing an insulating jacket on an outer surface of the first, second, and third sidewalls such that the insulating jacket is configured to reduce heat transfer from the hot body to the housing of the electro-mechanical device.

12. The method of claim 12, wherein the insulating jacket is made up of a fiberglass material.

13. The method of claim 10, wherein the space defined between the first, second, and third sidewalls is substantially greater than a size of the housing received therein.

14. The method of claim 13 further comprising defining an air gap between the housing of the electro-mechanical device and each of the first sidewall, the second sidewall, and the third sidewall.

15. The method of claim 10 further comprising fastening the backing plate with the bottom end of the housing.

16. The method of claim 15 further comprising defining at least one aperture on the backing plate such that the aperture on the backing plate is configured to receive a fastener therein for releasably fastening the shield assembly with the bottom end of the housing.

17. The method of claim 10 further comprising fastening the tab member to the bracket associated with the housing of the electro-mechanical device.

18. The method of claim 17 further comprising defining at least one aperture on the tab member such that the aperture on the tab member is configured to receive a fastener therein for releasably fastening the shield assembly with the bracket associated with the housing of the electro-mechanical device.

19. An engine comprising:
a combustor portion;
an exhaust portion;
a bleed valve for fluidly communicating the combustor portion with the exhaust portion;
an electro-mechanical device for actuating a position of the bleed valve;
a housing configured to enclose the electro-mechanical device; and
employing the method of claim 10 to shield the housing of the electro-mechanical device from heat radiated by the combustor portion.

20. The engine of claim 17, wherein the engine is a gas turbine engine.
